(19) United States
(12) Patent Application Publication
(10) Pub. No.: US 2026/0093260 A1
(43) Pub. Date: Apr. 2, 2026

(54) IMAGE-BASED DELOCALIZATION RECOVERY

(71) Applicant: Bear Robotics, Inc., Redwood City, CA (US)

(72) Inventor: Konstantin Stulov, Redwood City, CA (US)

(21) Appl. No.: 19/120,252

(22) PCT Filed: Feb. 26, 2024
(86) PCT No.: PCT/US2024/017252

§ 371 Date: Apr. 11, 2025

Related U.S. Application Data
(60) Provisional application No. 63/487,103, filed on Feb. 27, 2023.

(51) Int. Cl. G05D 1/622; G01S 17/89; G05D 1/243; G05D 1/246; G05D 1/43; G05D 105/30; G05D 111/10; G06T 7/73

(52) U.S. Cl. CPC G05D 1/622; G01S 17/89; G05D 1/243; G05D 1/246; G05D 1/43; G06T 7/74; G05D 2105/30; G05D 2111/10; G06T 2207/10028; G06T 2207/30244; G06T 2207/30252

(57) ABSTRACT

A computer-implemented method and apparatus to recover travel of a service robot, the method comprising: detecting a travel impediment relating to a first travel path to a destination for the service robot; responsive to detecting the travel impediment relating to the first travel path to the destination, determining that the service robot is delocalized by performing a comparison between a first pose estimate for the service robot and a second pose estimate for the service robot; responsive to determining that the service robot is delocalized, performing a relocalization operation of the service robot; and responsive to performing the relocalization operation of the service robot, initiating a second travel path to the destination.

### CROSS-REFERENCE TO RELATED APPLICATIONS

This application claims the benefit of U.S. Provisional Application No. 63/487,103, filed on Feb. 27, 2023, which is hereby incorporated by reference in its entirety.

### TECHNICAL FIELD

The disclosed subject matter relates generally to the technical field of mobile robots and/or delivery systems and, in some examples, to a solution for image-based delocalization recovery for a mobile robot.

### BACKGROUND

Mobile service robots operate in various service environments (from restaurants and stores to care facilities or conference centers). To efficiently accomplish their tasks (supplies delivery, sanitation operations, automated valet parking services), service robots must be able to recover when their path to a destination in the service environment appears blocked. To do so, the service robots must establish if the detected problem in reaching the destination is real, or the result of the service robot's reliance on uncertain or erroneous information about its location in the service environment (e.g., whether the robot has become “delocalized” during its travel). In case the service robot has in fact become delocalized, it must be able to recover and be able to resume its travel toward its destination.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a view of an example service robot that may be deployed within a location, such as a restaurant or care facility.

FIG. 2 is a block diagram illustrating one view of components and modules of a service robot, according to some examples.

FIG. 3 is a block diagram illustrating another view of components and modules of a service robot, according to some examples.

FIG. 4 is a block diagram illustrating another view of components and modules of a service robot, according to some examples.

FIG. 5 is a block diagram illustrating another view of components and modules of a service robot, according to some examples.

FIG. 6 is a flowchart illustrating a method for recovering travel of a service robot, implemented by components and modules of the service robot, according to some examples.

FIG. 7 is a flowchart illustrating a method for detecting the delocalization of a service robot, implemented by components and modules of the service robot, according to some examples.

FIG. 8 is a flowchart illustrating a method for performing a comparison of a first pose estimate and a second pose estimate, according to some examples.

FIG. 9 is a flowchart illustrating a method for robot relocalization, according to some examples.

FIG. 10 is a flowchart illustrating a method for robot delocalization detection according to some examples.

FIG. 11 is a block diagram illustrating components and modules of the service robot, according to some examples.

FIG. 12 is a flowchart illustrating a method, according to some examples, as implemented by components and modules of the service robot.

FIG. 13 is a flowchart illustrating a method for robot delocalization detection as implemented by components and modules of a service robot, according to some examples.

FIG. 14 is a block diagram showing a model system, according to some examples, that operates to create and maintain image localization models that are deployed at various service robots at one or more locations.

FIG. 15 is a block diagram showing a software architecture within which the present disclosure may be implemented, according to some examples.

FIG. 16 is a diagrammatic representation of a machine within which instructions for causing the machine to perform any one or more of the methodologies discussed herein may be executed, according to some examples.

FIG. 17 is a diagrammatic representation of a processing environment, in accordance with some examples.

FIG. 18 is a diagrammatic representation of an environment in which multiple service robots are deployed to respective locations or environments, such as restaurants, hospitals, or senior care facilities.

### DETAILED DESCRIPTION

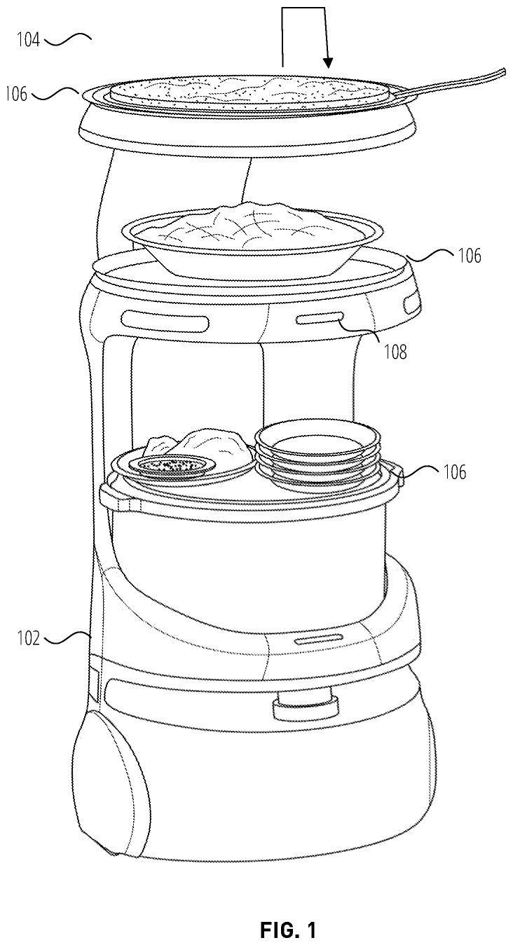

FIG. 1 is a view of an example service robot 104 that may be deployed within a location 1802, such as a restaurant or care facility. The service robot 104 has a housing 102 that accommodates various components and modules, including a locomotion system with wheels that enable the service robot 104 to propel itself within a service location. Navigation systems and perception systems are also accommodated within the housing 102. The housing 102 supports a number of trays 106 that can accommodate plates and other dishes that are delivered to and from a kitchen within a location 1802 to tables.

The service robot 104 can include multiple sensors, including exteroceptive sensors, for capturing information regarding an environment or location within which a service robot 104 may be operating, and proprioceptive sensors for capturing information related to the service robot 104 itself.

Examples of exteroceptive sensors include vision sensors (e.g., two-dimensional (2D), three-dimensional (3D), depth and RGB cameras), light sensors, sound sensors (e.g., microphones or ultrasonic sensors), proximity sensors (e.g., infrared (IR) transceiver, ultrasound sensor, photoresistor), tactile sensors, temperature sensors, navigation and positioning sensors (e.g., Global Positioning System (GPS) sensor). Visual odometry and visual-SLAM (simultaneous localization and mapping) can assist a service robot 104 in navigating in both indoor and outdoor environments where lighting conditions are reasonable and can be maintained. The 3D cameras, depth, and stereo vision cameras provide pose (e.g., position and orientation) information.

The service robot 104 can have a limited number (e.g., 1-4) of cameras, including a single, front-facing camera (e.g., robot camera 108). This setup ensures that the quantity of image data captured and to be processed is manageable, and that the image processing can be done efficiently and even entirely locally (e.g., using CPU compute). In some examples, the service robot can have a high-resolution front-facing camera and a small number of lower-resolution back-facing cameras. A front-facing camera operationally can take “up” images (images taken while the camera is facing upwards towards the obstacle). According to some examples, a camera can take “down” images (images taken while the camera is facing downwards towards the obstacle). According to some examples, a camera can take “middle” images (images taken while the camera is level with the floor). A service robot using a front-facing camera can recognize and categorize the objects in its environment if it is oriented so that the front-facing camera is directly aligned with the target object or set of objects.

The front-facing camera alignment with a target object can be achieved by rotating the service robot 104's body (e.g., by motor control of wheels of the service robot 104) to align the robot camera 108. The robot camera 108 itself can be moveable in multiple directions within or relative to the body of the service robot 104 to achieve or assist with its alignment with a target object or set of objects. For example, the robot camera 108 can be rotatably mounted within a socket or housing secured to the body of the service robot 104 and controlled by an electromechanical mechanism to rotate in multiple directions.

Examples of proprioceptive sensors include inertial sensors (e.g., tilt and acceleration), accelerometers, gyroscopes, magnetometers, compasses, wheel encoders, and temperature sensors. Inertial Measurement Units (IMUs) within service robot 104 can include multiple accelerometers and gyroscopes, as well as magnetometers and barometers. Instantaneous pose (e.g., position and orientation) of the service robot 104, velocity (linear, angular), acceleration (linear, angular), and other parameters can be obtained through IMUs.

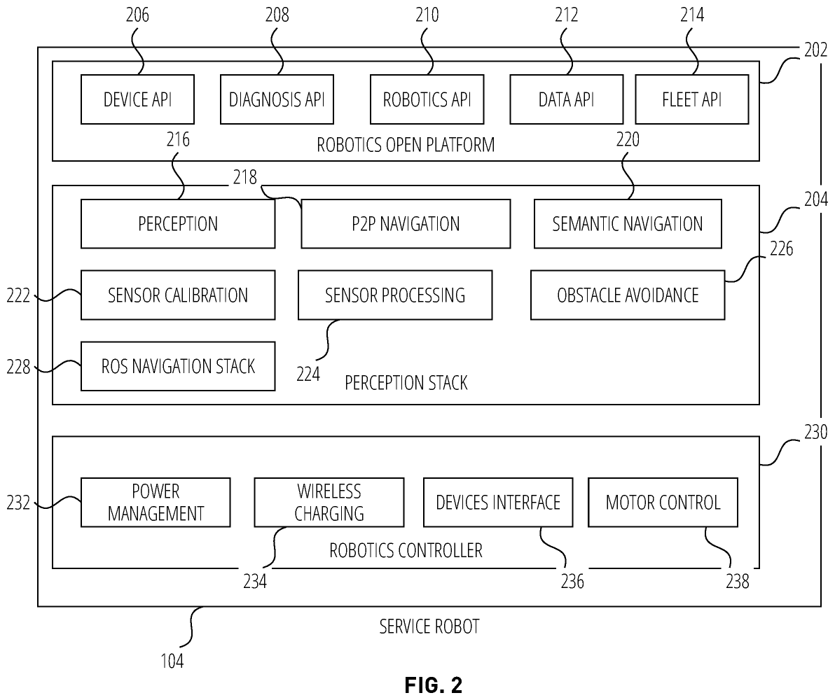

FIG. 2 is a block diagram illustrating one view of components and modules of a service robot 104, according to some examples. The service robot 104 includes a robotics open platform 202, a perception stack 204, and a robotics controller 230.

The robotics open platform 202 provides a number of Application Program Interfaces (APIs), including:
a device API 206
a diagnosis API 208
a robotics API 210
a data API 212; and
a fleet API 214

The perception stack 204 includes components that support:
perception 216
P2P navigation 218
semantic navigation 320
sensor calibration 222
sensor processing 224
obstacle avoidance 226.

A ROS navigation stack 228 also forms part of the perception stack 204.

The robotics controller 230 comprises components that support:
power management 232
wireless charging 234
devices interface 236
motor control 238.

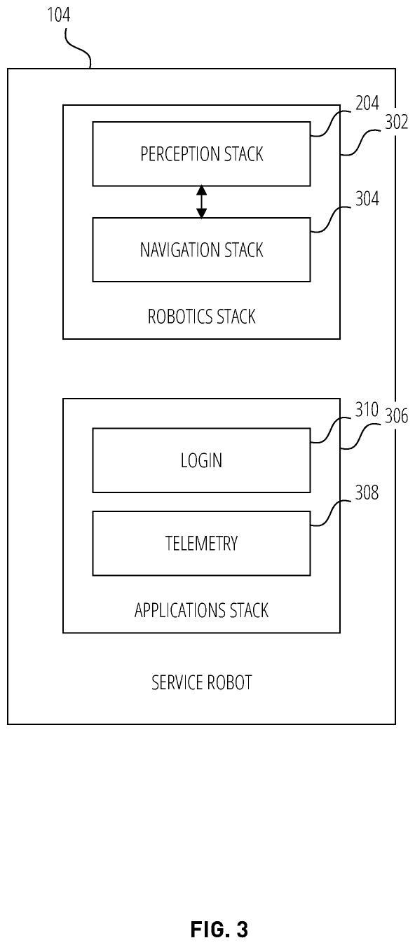

FIG. 3 is a block diagram illustrating another view of components and modules of a service robot 104, according to some examples. The service robot 104 includes a robotics stack 302 and an applications stack 306. The robotics stack 302, in turn, includes a navigation stack 304 and a perception stack 204. The applications stack 306 provides telemetry 308 and login 310 services for the service robot 104.

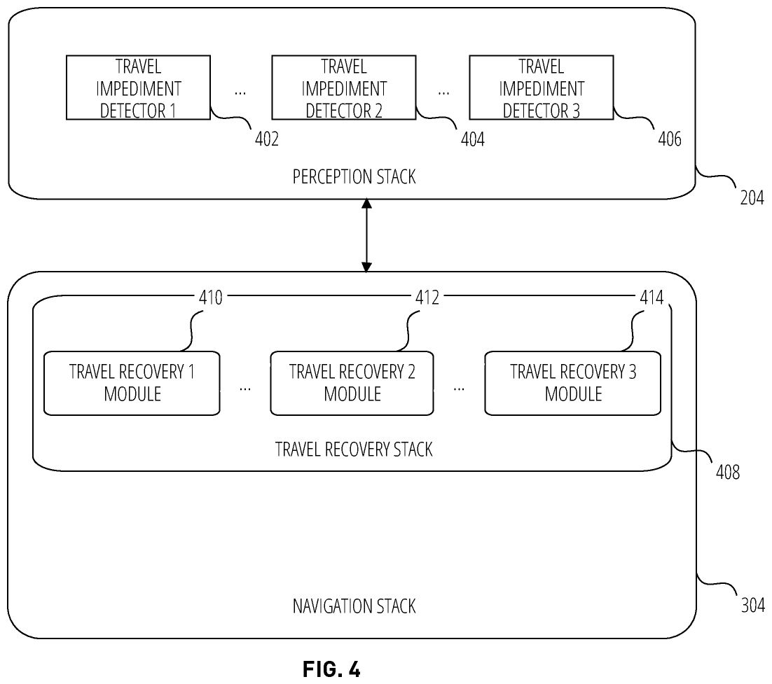

FIG. 4 is a block diagram illustrating another view of components and modules of a service robot 104, according to some examples. The perception stack 204 includes travel impediment detector travel impediment detector 402, travel impediment detector 404 and travel impediment detector 406. The navigation stack 304 includes a travel recovery stack 408, which in turn includes example modules such as a travel recovery module 410 and a travel recovery module 414. In some examples, the navigation stack 304 can include a ROS navigation stack.

Example: Robot Travel Recovery With Delocalization Detection

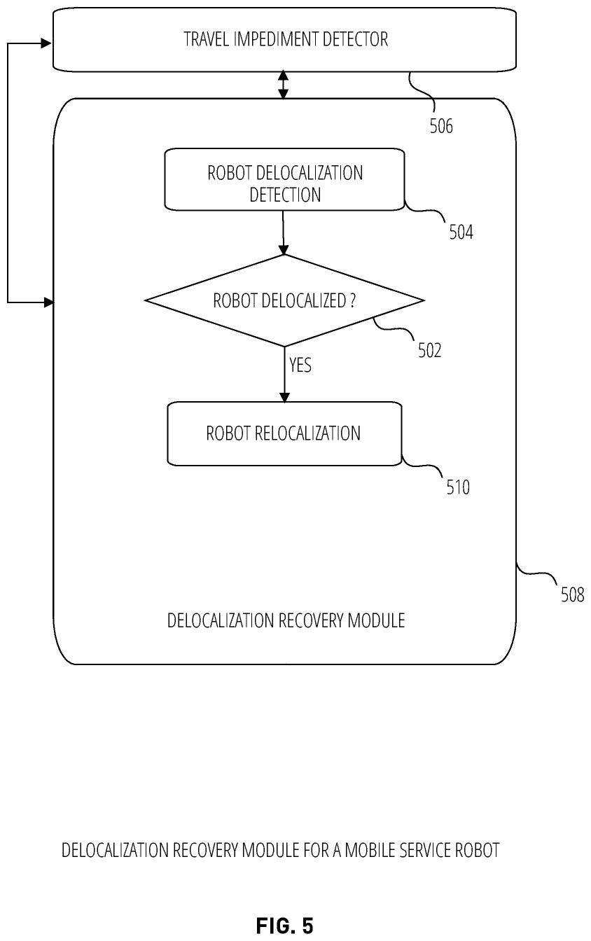

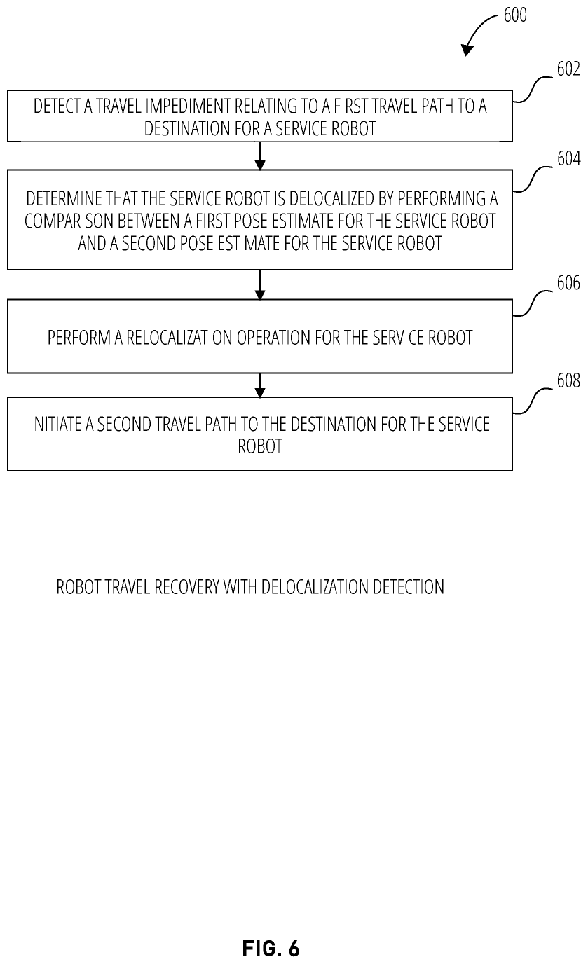

FIG. 5 is a block diagram illustrating another view of components and modules of a service robot 104, according to some examples (see FIG. 6 for a related flowchart).

The service robot 104 uses a travel impediment detector 506 to detect an impediment related to a first travel path to a target destination. The impediment can be an unexpected physical obstacle in the environment (a person, a moved chair, etc.). However, the service robot 104 could erroneously perceive an impediment along its path to the destination due to the service robot having become delocalized: that is, the service robot may have outdated or erroneous information about its location in the service environment. Upon detecting that its travel path to the destination has been impeded, the service robot 104 uses a delocalization recovery module 508 to check whether it has become delocalized, and if so, to relocalize itself before attempting to reach its destination.

A delocalization recovery module 508 includes one or more of at least the following modules:
a robot delocalization detection module 504;
a decision node (“robot delocalized?”) 502; and
a robot relocalization module 510.

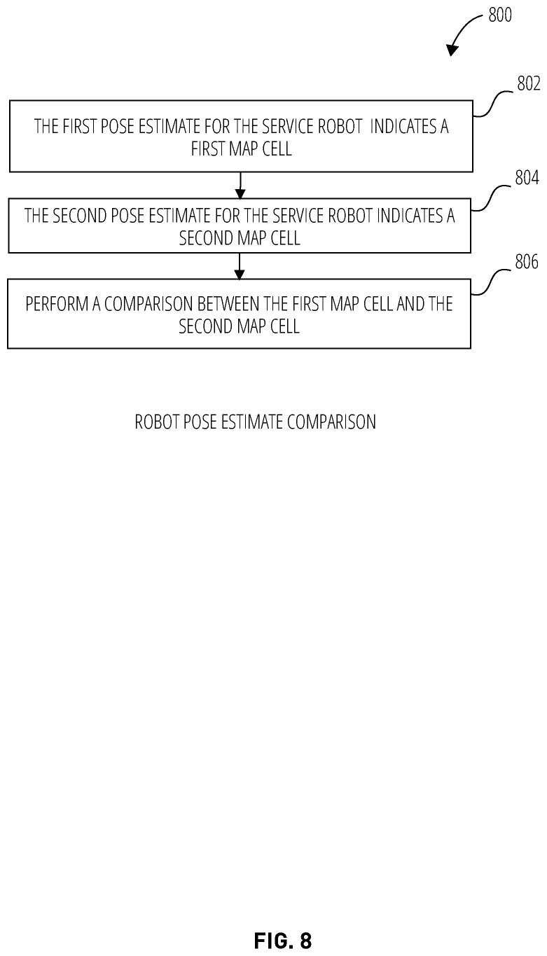

In some examples, the robot delocalization detection module 504 automatically detects whether the service robot 104 has become delocalized by comparing a first pose estimate for the service robot (computed by a first localization model) with a second pose estimate for the service robot (computed by a second localization model). The robot delocalization detection module 504 automatically determines that the service robot 104 has become delocalized if the first pose estimate does not match the second pose estimate (e.g., see detailed description of FIG. 8 for details).

If the robot delocalization detection module 504 detects that the service robot 104 has become delocalized, a relocalization operation executed by a robot relocalization module 510 operationally causes the robot to obtain an updated estimate of its position in the service environment. The robot relocalization operation can include reinitializing the first localization model with the second pose estimate, and then using the reinitialized first localization model to compute an updated pose estimate for the service robot 104. After the service robot 104 is relocalized, the robot continues traveling to the destination along a recomputed travel path.

### Travel Impediment Detector

The travel impediment detector 506 detects an impediment related to a service robot 104 attempting to reach a destination by means of a travel path. The travel impediment detector 506 uses vision sensors (e.g., two-dimensional (2D), three-dimensional (3D), depth and RGB cameras), light sensors, sound sensors (e.g., microphones or ultrasonic sensors), proximity sensors (e.g., infrared (IR) transceiver, ultrasound sensor, photoresistor), tactile sensors, temperature sensors, navigation and positioning sensors (e.g., Global Positioning System (GPS) sensor), visual odometry and visual-SLAM (simultaneous localization and mapping).

The travel impediment detector 506 can process images captured by the robot camera 108 (according to some examples, a front-facing camera) and use a pre-trained object recognition and object type identification model (e.g., a TensorFlow model such as one in TensorFlow 2 Detection Model Zoo, an OpenCV model, a Detectron2 model) to label objects in the processed images and identify their types.

The travel impediment detector 506 examines detected bounding boxes around detected objects with identified most likely object types. Each bounding box and respective identified object type are accompanied by a computed score, indicating how likely the detected object is to be of the respective type, according to the model used by the travel impediment detector. The travel impediment detector 506 can use tunable thresholds to discard or isolate objects whose identified types have low scores.

The travel impediment detector 506 can perform a depth estimate while processing camera images to determine if the path is blocked. The service robot 104 uses a depth camera and takes depth camera images, to be processed by the travel impediment detector 506.

According to some examples, a travel impediment detector 506 uses the dimensions of the identified bounding box for a detected obstacle to compute a distance indicator for the service robot and the potential obstacle, an indicator that can be an estimate of the distance between the service robot 104 and the potential obstacle. In some examples, the distance indicator is a binary value corresponding to whether the potential obstacle is close enough to the robot to impede its path. Computing a distance indicator can use a depth estimate from a depth camera image. Computing the distance indicator can use a standard size for a respective object type. Computing a distance indicator can use a focal length measure for the robot camera. The computing of the distance indicator can be implemented as a rule or a set of rules. In some examples, the computing of the distance indicator is done by using a machine-learned model.

### Robot Delocalization Detection Module

The robot delocalization detection module 504 computes a delocalization indicator of whether the service robot 104 has become delocalized by automatically comparing a first pose estimate for the service robot (computed by a first localization model) with a second pose estimate for the service robot (computed by a second localization model). Performing a comparison between the first and the second pose estimate involves automatically checking if the first and second pose estimate match (see the detailed description of FIG. 8 for examples). In some examples, the delocalization indicator corresponds to a value of a binary variable (e.g., “1” for “robot delocalized”/“0” for “robot not delocalized”, or equivalent). In some examples, the delocalization indicator corresponds to a numeric value.

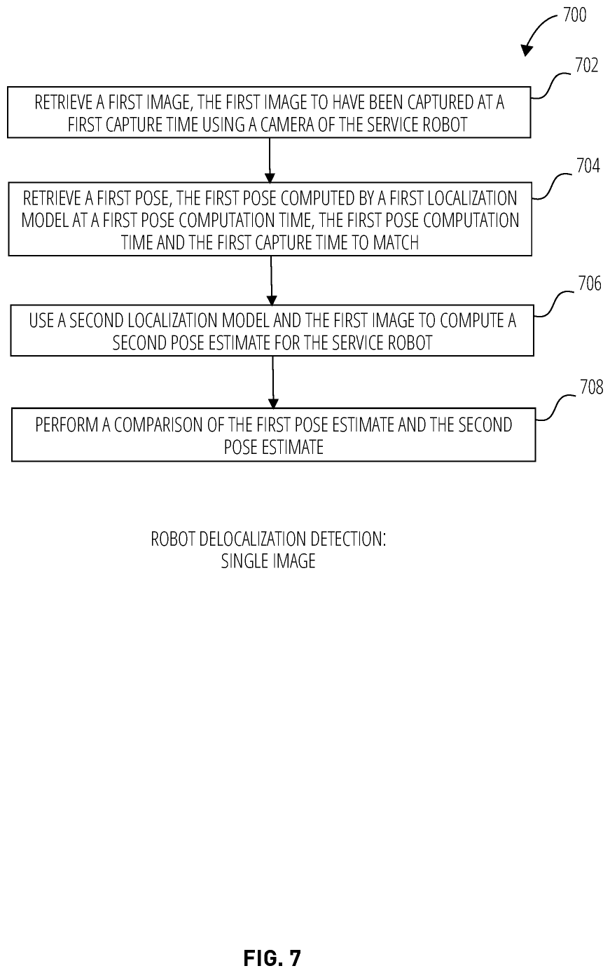

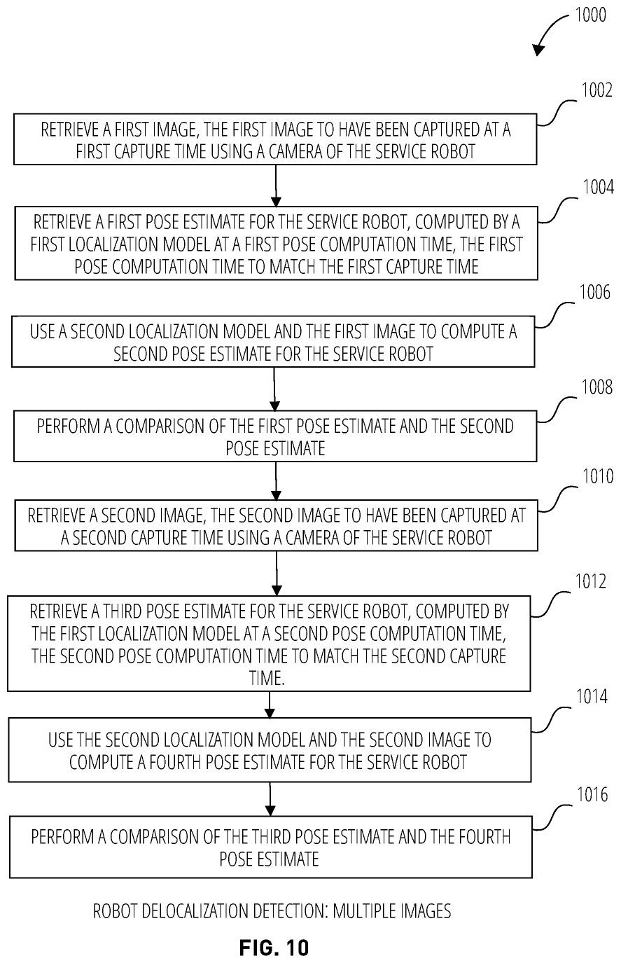

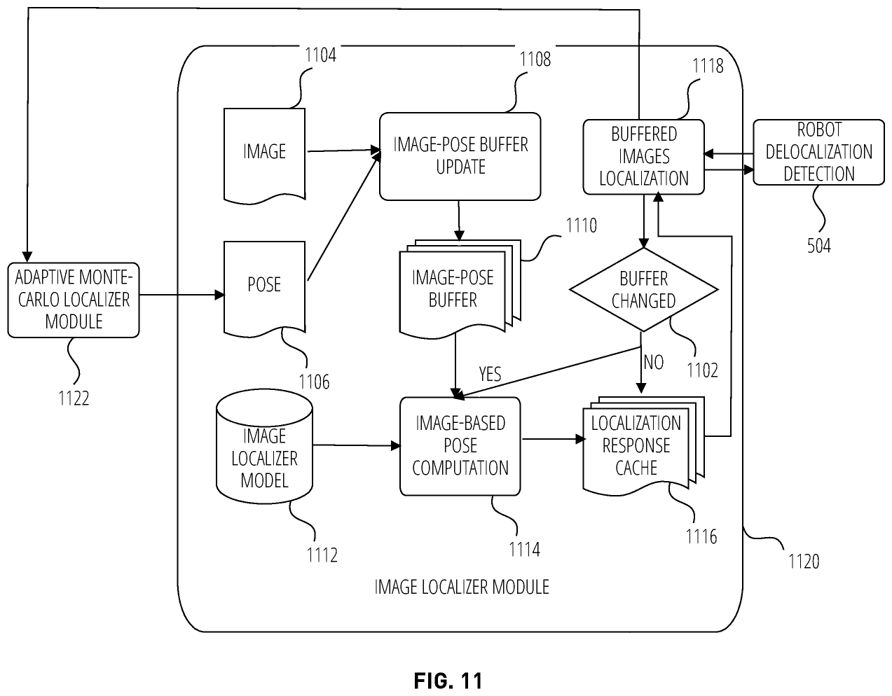

FIG. 7 and FIG. 10 show example methods for robot delocalization detection, while FIG. 11 shows a block diagram illustrating how an example robot delocalization module interacts with other example modules of the service robot 104.

### Service Environment Data for Robot Pose Estimate Computation

The first pose estimate is based on a first type of data automatically acquired from the service environment (e.g., laser scanning data), while the second pose estimate is based on a second type of data automatically acquired from the service environment (e.g., images captured by a robot camera 108 of the service robot 104). In some examples, the first pose estimate is computed based on a first type of data (e.g., images, acquired by a front-facing camera of the service robot), while the second estimate is computed based on the same type of data, but collected using a different process (e.g., images acquired by a back-facing or side-facing camera of the service robot 104).

The data types used by the first and/or, respectively, second localization model in order to compute pose estimates for the service robot can include laser scanning data, image data, depth camera data, Wi-Fi signal strength data, odometry data, sonar data and more.

The first type of data and the second type of data used by the computation of service robot poses are acquired (captured) at a first, and respectively, second time, where the first and second times match. Two recorded times (timestamps) match if they are identical or if the numerical difference between them is smaller than a predetermined time threshold.

The first pose estimate is automatically computed by the first localization model upon the acquisition of the first type of data, or within a predetermined time period afterwards. Similarly, the second pose estimate can be automatically computed by the second localization model upon the acquisition of the second type of data (or within a predetermined time period afterwards).

In some examples, the first pose estimate is automatically computed responsive to the receiving, by the first localization model, of a request for a pose estimate computation (or within a predetermined time period afterward). Similarly, the second pose estimate can be automatically computed upon the receiving, by the second localization model, of a request for a pose estimate computation (or within a predetermined time period afterward).

### Localization Models for Robot Pose Estimate Computation

The service robot 104 uses a probabilistic localization method to compute a first pose estimate for the service robot in the context of a pre-computed map of the service environment. The service robot can use an Adaptive Monte Carlo localization (AMCL) method (e.g., see the amcl node in the ROS navigation stack) as executed by an example Adaptive Monte Carlo localizer module 1122 (see the detailed description of FIG. 11). In some examples, the service robot 104 computes a first pose estimate based on automatically acquired laser scanning data. In some examples, the service robot uses other localization algorithms (e.g., General Monte Carlo localization (GMCL)) and the same or additional types of automatically acquired service environment data (e.g., odometry data, sonar data). In some examples, the service robot 104 can compute a first pose estimate using an image-based localization method and an image captured by a robot camera 108.

In some examples, the service robot 104 uses a probabilistic localization algorithm to compute a second pose estimate for the service robot in the context of a pre-computed map of the service environment. The service robot uses an image-based localization method to compute a second pose estimate for the service robot based on an image captured by a robot camera 108. In some examples, the service robot 104 uses an AMCL method (or a GMCL method) to compute a second pose estimate for the service robot based on automatically captured laser scanning data, odometry data, sonar data, etc.

In some examples, the first pose estimate is based on a first type of data automatically acquired from the service environment (e.g., laser scanning data), while the second pose estimate is based on a second type of data automatically acquired from the service environment (e.g., images captured by a service robot camera 108). The first pose estimate can be computed based on a given type of data (e.g., images, acquired by a front-facing camera of the service robot), while the second estimate can be computed based on the same type of data, but collected using a different process (e.g., images acquired by a back-facing or side-facing camera of the service robot). In some examples, the first pose estimate and the second pose estimate are computed using the same type of localization method, but using diverse types of data, or datasets collected in differing ways. The first localization model and the second localization model can be the same. The first pose estimate and the second pose estimate can be computed using diverse types of localization methods and/or diverse types of data, or datasets collected in differing ways.

### Robot Relocalization Module

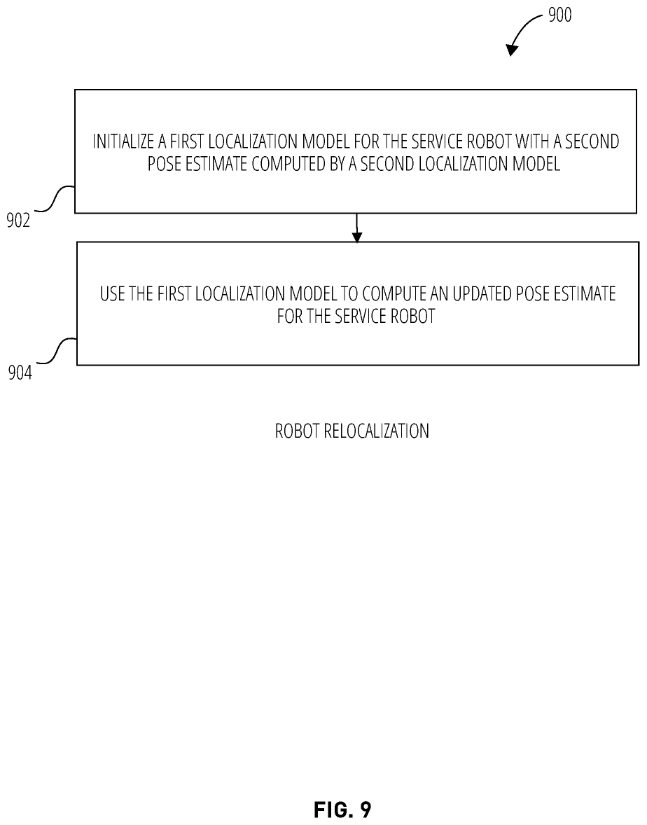

If the robot delocalization detection module 504 detects that the service robot 104 has become delocalized, a robot relocalization module 510 performs an automatic relocalization operation in order to relocalize the service robot 104 robot, that is to operationally cause the service robot 104 to compute an updated estimate of its position in the service environment. In some examples, the robot relocalization operation performed by the robot relocalization module 510 involves reinitializing a first localization model with a second pose estimate and using the first localization model to compute an updated pose estimate for the service robot 104 (see the detailed description of FIG. 9 for more details about an example robot relocalization method).

FIG. 6 is a flowchart illustrating a computer-implemented method 600 for recovering travel of a service robot 104, according to some examples. At operation 602, the method detects a travel impediment relating to a first travel path to a destination for the service robot. At operation 604, responsive to detecting the travel impediment relating to the first travel path to the destination, the method 600 automatically detects that the service robot 104 is delocalized by performing a comparison between a first pose estimate for the service robot and a second pose estimate for the service robot (see FIG. 7 for some examples). At operation 606, responsive to determining that the service robot is delocalized, the method performs a relocalization operation of the service robot. At operation 608, responsive to performing a relocalization operation of the service robot, the method initiates a second travel path to the service robot's destination.

### Example: Robot Delocalization Detection With Single Captured Image

FIG. 7 is a flowchart illustrating a method 700 for robot delocalization detection, according to some examples. The method 700 is implemented by components and modules of the service robot 104, such as the robot delocalization detection module 504. At operation 702, method 700 retrieves a first image, the first image having been captured at a first capture time, using a robot camera 108 of the service robot 104. At operation 704, method 700 retrieves a first pose estimate for the service robot 104, the first pose estimate having been computed by a first localization model at a first pose computation time that matches the first capture time.

At operation 706, method 700 computes a second, image-based pose estimate for the service robot, using a second localization model and the captured first image. At operation 708, method 700 performs a comparison of the first pose estimate and the second, image-based pose estimate.

### Comparison of Robot Pose Estimates

FIG. 8 is a flowchart illustrating a method 800 for performing a comparison of a first pose estimate for a service robot 104 and a second pose estimate for a service robot 104, according to some examples. At operation 802, the first pose estimate indicates a first map cell. At operation 804, the second pose estimate indicates a second map cell. At operation 806, the performing of a comparison between a first pose estimate and a second pose estimate includes performing a comparison between the first map cell and the second map cell.

The first pose estimate indicating a first map cell may include a first confidence score, the first confidence score corresponding to how likely the first map cell is to correspond to the location of the service robot 104.

Similarly, the second pose estimate indicating a second map cell may include a second confidence score associated with the second map cell. The performing of the comparison between the first and second pose estimates may include automatically checking that the first and/or second confidence score exceeds a predetermined confidence threshold, or automatically checking if the magnitude of the difference between the first and second score exceeds a predetermined threshold.

Tessellated maps A first pose estimate may indicate a first tile (or cell) in a previously computed first tessellation (or first tessellated map) corresponding to the service environment, or a portion thereof. A second pose estimate may indicate a second tile (or cell) in a previously computed second tessellation (or second tessellated map) for the service environment, or a portion thereof. The shapes of the first and second tiles (or cells) may be the same or differ. For same-shape first and second tiles, the dimensions of the first and second tiles may be the same or differ.

Grid maps Either the first map, or the second map (or both) may be grid maps. If both the first and second maps are grid maps, the dimensions of the first grid map may be the same as the dimensions of the second grid map. The grid resolution for the first grid map be the same or different from the grid resolution for the second grid map. In some examples, the first map and the second map may be the same grid map.

### Performing a Comparison of Tiles (or Cells)

Performing a comparison between a first tile (or cell) and a second tile (or cell) involves automatically checking whether the first tile and the second tile match, for example, in the context of a shared coordinate system. Performing a comparison between the first tile and second tile (or first and second cells) may include applying a set of transformations to the first tile and/or the second tile in the context of a shared coordinate system and then automatically comparing a first transformed tile and a second transformed tile with respect to the shared coordinate system.

Matching Tiles (or Cells) In some examples, the first and second tiles match if their surface and or position overlap with respect to a shared coordinate system is greater than a predetermined minimum threshold based on the first set of tile dimensions, the second set of tile dimensions, the position of the first tile, and/or the position of the second tile with respect to the shared coordinate system. The first and the second tiles may match if a distance between the centers of the tiles, or between other corresponding tile points (e.g., corresponding tile corners, etc.) is smaller than a predetermined threshold. In some examples, the first pose estimate indicates a first map cell with respect to a map, the second pose estimate indicates a second map cell with respect to the same map, and the first map cell matches the second map cell because the first map cell is the same as the second map cell.

Additional Examples A first pose estimate for a service robot 104 may indicate a first set of coordinates in the context of a coordinate system (for example, an x-axis coordinate, a y-axis coordinate, or a yaw angle). Similarly, a second pose estimate for a service robot 104 may indicate a second set of x-axis and y-axis coordinates and a second yaw angle. The first pose estimate and the second pose estimate match if a distance indicator computed using the first set of coordinates and the second set of coordinates is smaller than a predetermined distance threshold. In some examples, the distance indicator computation may use a Euclidean distance computation, a weighted Euclidean distance computation, or other distance metrics known in the art.

A first pose estimate for a service robot 104 may indicate a first map cell (or tile), x-axis and y-axis offsets within the first map cell (or tile), and an orientation (a yaw angle). A second pose estimate for a service robot 104 may indicate a second map cell (or tile), x-axis and y-axis offsets within second first map cell (or tile), and an orientation (a second yaw angle).

Performing a comparison between any two pose estimates (e.g., a N-th pose estimate and a M-th pose estimate, where N and M are integers) may be performed using any of the methods described herein for comparing a first pose estimate and a second pose estimate. In some examples, N=3 and/or M=4. A third pose estimate may indicate a third map cell and/or a fourth pose estimate may indicate a fourth map cell. The performing of a comparison between a third pose estimate and a fourth pose estimate may include performing a comparison between a third map cell and a fourth map cell.

### Example: Robot Relocalization

FIG. 9 is a flowchart illustrating a method 900 for robot relocalization, according to some examples. At operation 902, the first localization model for the service robot 104 is initialized with a second pose estimate for service robot 104 computed by a second localization model. At operation 904, the first localization model computes an updated pose estimate for the service robot.

In some examples, a first localization model of the service robot 104 uses a probabilistic localization method to compute a pose estimate for the service robot in the context of a pre-computed map of the service environment. An example first localization model of the service robot 104 uses an Adaptive Monte Carlo localization (AMCL) method (e.g., see the amcl node in the ROS navigation stack). The service robot 104 may use the AMCL method to compute a pose estimate based on automatically acquired laser scanning data. The service robot 104 may use other localization algorithms (e.g., General Monte Carlo localization (GMCL)), and the same or additional types of automatically acquired service environment data (e.g., odometry data, sonar data). The service robot 104 may compute a first pose estimate using an image-based localization method and an image captured by a robot camera 108.

In some examples, the second pose estimate used to initialize the first localization model is computed by a second localization model using an image-based localization method. The image-based localization method used by the second localization model computes the second pose estimate based on an image captured by robot camera 108 of the service robot 104.

In some examples, the second pose estimate used to initialize the first localization model is computed by a second localization model using an AMCL method (or a GMCL method) and one or more of the following data types: automatically captured laser scanning data, odometry data, sonar data, Wi-Fi signal strength data and more.

### Example: Robot Delocalization Detection With a Sequence of Images

FIG. 10 is a flowchart illustrating a method 1000 for robot delocalization detection, as implemented by components or modules of service robot 104 such as the robot delocalization detection module 504, according to some examples. The method 1000 detects whether a service robot 104 has become delocalized by performing pairwise-comparisons between pose estimates for the service robot 104, where the pose estimates correspond to estimates of the robot's pose at a specific time, as computed by one or several localization models and/or using one or several data types.

At operation 1002, the method 1000 retrieves a first image, the first image having been captured at a first capture time using a camera of the service robot 104. At operation 1004, the method 1000 retrieves a first pose estimate for the service robot 104, the estimate having been computed by a first localization model at a first pose computation time that matches the first capture time. Two recorded times (or timestamps) match if they are identical or if the numerical difference between them is smaller than a predetermined time threshold.

At operation 1006, the method 1000 computes a second, image-based pose estimate for the service robot 104 by using a second localization model, which takes the first image as input and outputs the second pose estimate. At operation 1008, the method 1000 performs a first comparison of the first pose estimate and the second, image-based pose estimate (see detailed description for FIG. 8).

At operation 1010, the method 1000 retrieves a second image, the second image having been captured at a second capture time using a camera of the service robot 104. At operation 1012, the method retrieves a third pose estimate for the service robot 104 computed by the first localization model at a second pose computation time that matches the second capture time. At operation 1016, the method computes a fourth, image-based pose estimate for the service robot 104 by using the second localization model that takes the second image as input. At operation 1018, the method 1000 performs a second comparison of the third pose estimate and the fourth, image-based pose estimate.

### Independence of (Image, Pose) Tuples

In some examples, a method seeks to approximate the acquisition of independent data points to obtain a better estimate of whether the service robot 104 has become delocalized. An example method requires that the difference between the capture times for the second image and the first image is greater than a minimum predetermined time threshold, or that a distance between the fourth pose estimate and the second pose estimate is greater than a minimum predetermined distance threshold.

### Delocalization Indicators

Example method 1000 computes an indicator of whether a service robot 104 is delocalized based on combining the results of a first comparison (involving the first and second pose estimates) and, respectively, of a second comparison (involving the third and the fourth pose estimates). Combination functions such as Boolean functions (AND, OR, etc.) or other functions may be used to automatically combine the results of the first comparison and the second comparison. Example method 1000 assigns the delocalization indicator a value indicative of the service robot 104 being delocalized if the first comparison automatically detects a mismatch between the first and second pose estimates for the service robot 104 and the second comparison automatically detects a mismatch between the third and fourth pose estimates for the service robot 104.

Example method 1000 computes a partial delocalization indicator of whether the service robot 104 is delocalized based on the result of a first comparison between the first pose estimate and the second pose estimate. Example method 1000 computes a partial delocalization indicator of whether the service robot 104 is delocalized based on the result of a second comparison between the third pose estimate and the fourth pose estimate. According to some examples, the method 1000 computes an indicator of whether the service robot 104 is delocalized by automatically combining partial delocalization indicators. According to some examples, the method 1000 uses Boolean combination functions (e.g., AND, OR, etc.), majority voting functions, or other functions to automatically combine the values of partial delocalization indicators.

### Additional Examples

An example method 1000 may retrieve images captured at image capture times, and use the first localization model to generate a first set of pose estimates at pose estimate computation times matching respective image capture times. The number of images captured may be at least 3 or at most 5. An example method 1000 uses the second localization model and the images captured at image capture times to compute a second set of pose estimates at new pose estimate computation times matching the image capture times. Each estimate in the first set of pose estimates has a corresponding estimate in the second set of pose estimates, where the correspondence is based on matching computation times for the pose estimates.

An example method 1000 automatically computes partial delocalization indicators of the service robot 104 being delocalized based on performing comparisons of estimates in the first set of pose estimates with their corresponding estimates in the second set of pose estimates. An example method 1000 may use Boolean combination functions (e.g., AND, OR, etc.), majority voting function, or other functions to automatically combine the values of partial delocalization indicators. Method 1000 may output a delocalization indicator that indicates the robot is delocalized if each of the performed comparisons automatically detects that a pose estimate in the first set of pose estimates does not match a respective pose estimate in the second set of pose estimates. Method 1000 may indicate that the service robot 104 is delocalized if one, or many, or all partial delocalization indicators are greater or equal to one or more predetermined thresholds (e.g., a predetermined threshold of 1, where 1 corresponds to a robot being delocalized and 0 corresponds to a robot not being delocalized).

### Example: Robot Delocalization Detection

FIG. 11 is a block diagram illustrating a number of components and modules of the service robot 104, according to some examples. As the service robot 104 travels toward its destination, the robot camera 108 captures an example image 1104 of the service environment at a first image capture time.

### Adaptive Monte-Carlo Localizer Module

A localizer module such as the Adaptive Monte-Carlo localizer module 1122 of the service robot 104 computes a first pose estimate 1106 for the service robot 104 in the context of a pre-computed map of the service environment and at a first computation time, the first computation time to match the first capture time for captured image 1104.

The Adaptive Monte-Carlo localizer module 1122 uses a probabilistic localization method for robot pose computation, such as the Adaptive Monte Carlo localization (AMCL) method (e.g., as implemented by the amcl node in the ROS navigation stack). The Adaptive Monte-Carlo localizer module 1122 uses the AMCL method to compute a first pose estimate based on automatically acquired laser scanning data. In some examples, the service robot 104 computes a pose estimate using an example localizer module that implements alternative or additional localization algorithms such as General Monte Carlo localization (GMCL). An example localizer module may use laser scanning data, odometry data, sonar data, or other applicable types of data. An example localizer module may compute a first pose estimate using an image-based localization method and an image captured by a robot camera 108 of the service robot 104.

### Image Localizer Module

The image localizer module 1120 of the service robot 104 receives the captured image 1104 and the computed pose estimate 1106; its image-pose buffer update 1108 module updates an image-pose buffer 1110 by adding the (image 1104, pose estimate 1106) pair to the buffer. As the service robot 104 travels in the service environment, the image localizer modules 1120 adds one or more automatically generated (image, pose estimate) pairs to the image-pose buffer 1110. The image-pose buffer 1110 may be a circular buffer.

As previously seen in FIG. 5, upon detecting a potential travel impediment in the path of a service robot 104 to a destination, a delocalization recovery module 508, via a robot delocalization detection module 504, checks whether the robot has become delocalized. As seen in FIG. 11, the robot delocalization detection module 504 calls the buffered images localization component 1118 of image localizer module 1120. Upon being called, the buffered images localization component 1118 of the image localizer module 1120 checks if the image-pose buffer 1110 has changed since the buffered images localization component 1118 was last called.

In some examples, if additional (image, pose estimate) pairs were added to the image-pose buffer 1110, the image-based pose computation 1114 component of the image localizer module 1120 uses an image localizer model 1112 to compute additional image-based pose estimates (not shown) for some or all images newly added to the image-pose buffer 1110. Additional images may be automatically selected for image-based pose estimate computation based on a selection criterion (e.g., selecting the M most-recently captured or the N earliest captured additional images, where M and N are predetermined thresholds; maximizing a diversity indicator of a selected image set diversity with respect to the positions and/or orientations of robot camera 108 when capturing the images in the selected image set; maximizing a diversity indicator of a selected image set diversity with respect to the capture times for the images in the selected image set, and so forth).

The resulting [image, pose estimate, image-based pose estimate] tuples are stored in the localization response cache 1116 of the image localizer module 1120.

If the contents of the image-pose buffer 1110 have not changed since the buffered images localization component 1118 was last called, the buffered images localization component 1118 returns the current content of the localization response cache 1116, which consists of the currently stored [image, pose estimate, image-based pose estimate] tuples.

The robot delocalization detection module 504 of a delocalization recovery module 508 (e.g., see FIG. 5) calls the buffered images localization component 1118 of the image localizer module 1120. The buffered images localization component 1118 returns the set of [image, pose estimate, image-based pose estimate] tuples stored in the localization response cache 1116 of the image localizer module 1120. The robot delocalization detection module 504 may compute a delocalization indicator of the service robot 104 being delocalized based on performing comparisons between the pose estimates and corresponding image-based pose estimates in the returned tuples (e.g., see FIG. 10 for example details).

### Example: Robot Delocalization Detection With Rotation-in-Place

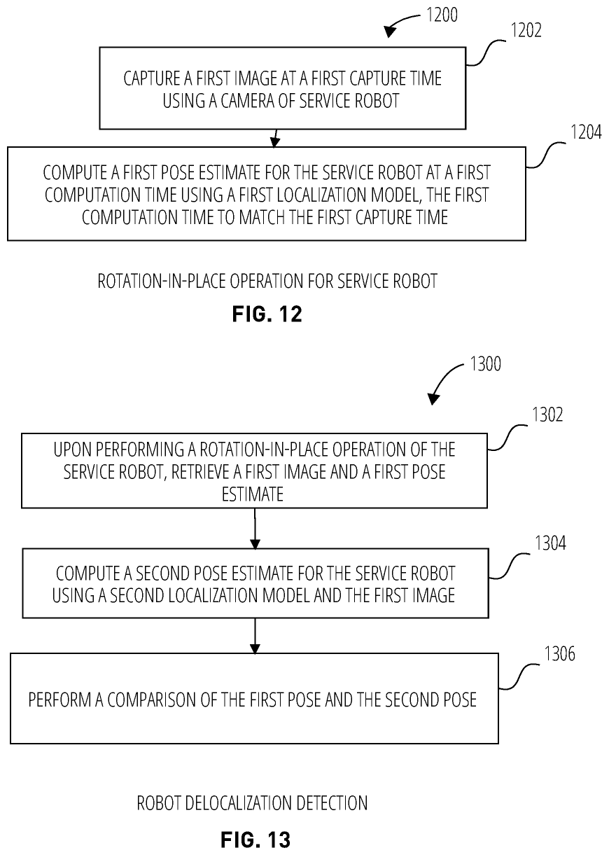

FIG. 12 is a flowchart illustrating a method 1200, according to some examples, as implemented by components and modules of the service robot 104. Upon detecting a travel impediment in the path of the service robot 104 to its destination, the delocalization recovery module 508 of service robot 104 (not shown) checks whether the service robot 104 has become delocalized (e.g., see FIG. 5). The robot delocalization detection module 504 (not shown) of the delocalization recovery module 508 (not shown) implements an example method 1200 for a rotation-in-place operation of the service robot 104.

### Rotation-in-Place of the Service Robot

According to some examples, the service robot 104 performs a rotation in place during which a first image is captured at a first capture time using the robot camera 108 of the service robot 104. A first localization model is used to compute a first pose estimate for the service robot 104 at a first pose computation time, the first pose computation time to match the first capture time.

According to some examples, the robot delocalization detection module 504 of the service robot 104 causes the service robot 104 to perform data gathering (e.g., image collection) operations such as: full (360 degrees) rotation-in-place, partial rotation to the left, partial rotation to the right, etc. The robot camera 108 of the service robot 104 captures a first image at a first capture time during an example such data gathering operation. A first localization model may be used to compute a first pose estimate for the service robot 104 at a first pose computation time, the first pose computation time to match the first capture time.

### Robot Delocalization Detection With Rotation-in-Place

FIG. 13 is a flowchart illustrating a method 1300 for robot delocalization detection as implemented by components and modules of the service robot 104, according to some examples. The example method 1300 is implemented by the robot delocalization detection module 504 (not shown, see FIG. 5 for an example). At operation 1302, upon the method 1300 having caused the service robot 104 to perform a rotation-in-place operation (e.g., see FIG. 12), method 1300 accesses a first image and a first pose estimate for the service robot computed by a first localization model. At operation 1304, method 1300 uses a second localization model and the first image to compute a second pose estimate for the service robot 104. At operation 1306, method 1300 performs a comparison of the first pose estimate and the second pose estimate. In some examples, the method 1300 computes a delocalization indicator of the service robot 104 being delocalized based on the results of the comparison between the first pose estimate and the second pose estimate. The value of the delocalization indicator is automatically set to a value indicative of the robot being delocalized if the first pose estimate does not match the second pose estimate.

### Service Robot: Overview

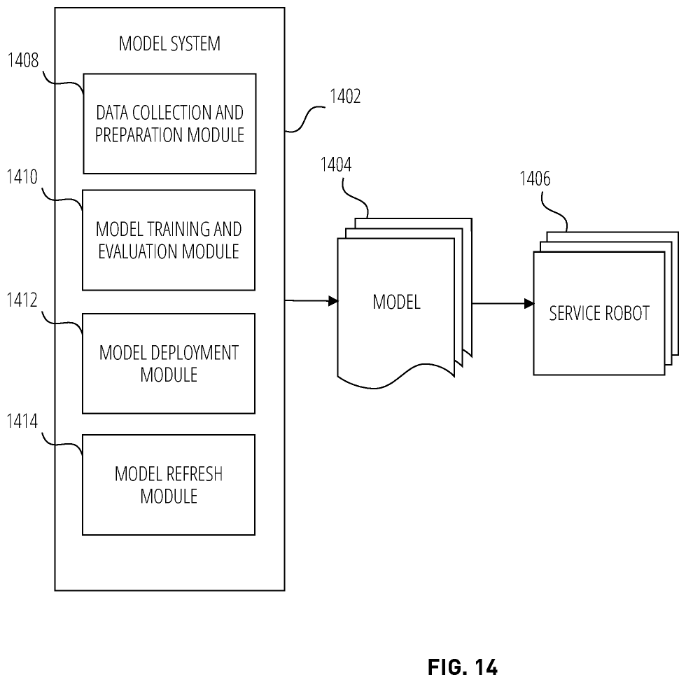

FIG. 14 is a block diagram showing a model system 1402 according to some examples, that operates to create and maintain image localization model 1404 that are deployed at various service robots 104 at one or more locations 1802. The model system 1402 may include the following components or modules:
Data collection and preparation module 1408
Model training and evaluation module 1410
Model deployment module 1412; and
Model refresh module 1414.

Further details regarding the operations of these example modules are provided below.

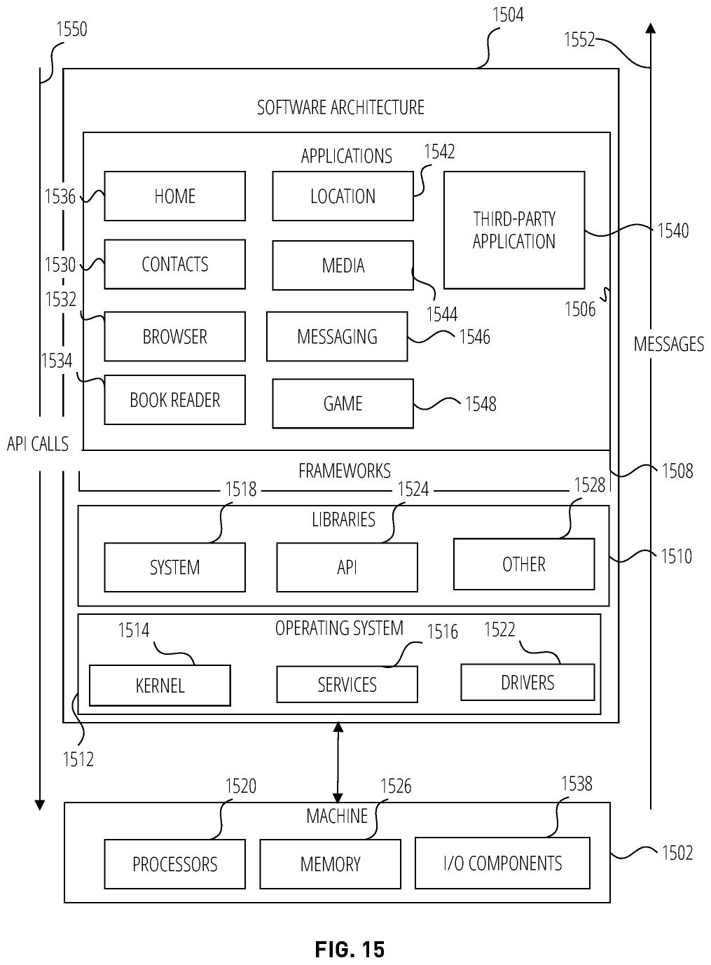

FIG. 15 is a block diagram illustrating a software architecture 1504, which can be installed on any one or more of the devices described herein. The software architecture 1504 is supported by hardware such as a machine 1502 that includes processors 1520, memory 1526, and I/O components 1538. In this example, the software architecture 1504 can be conceptualized as a stack of layers, where each layer provides a particular functionality. The software architecture 1504 includes layers such as an operating system 1512, libraries 1510, frameworks 1508, and applications 1506. Operationally, the applications 1506 invoke API calls 1550 through the software stack and receive messages 1552 in response to the API calls 1550.

The operating system 1512 manages hardware resources and provides common services. The operating system 1512 includes, for example, a kernel 1514, services 1516, and drivers 1522. The kernel 1514 acts as an abstraction layer between the hardware and the other software layers. For example, the kernel 1514 provides memory management, Processor management (e.g., scheduling), component management, networking, and security settings, among other functionalities. The services 1516 can provide other common services for the other software layers. The drivers 1522 are responsible for controlling or interfacing with the underlying hardware. For instance, the drivers 1522 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, and power management drivers.

The libraries 1510 provide a low-level common infrastructure used by the applications 1506. The libraries 1510 can include system libraries 1518 (e.g., C standard library) that provide functions such as memory allocation functions, string manipulation functions, mathematic functions, and the like. In addition, the libraries 1510 can include API libraries 1524 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., Web Kit to provide web browsing functionality), and the like. The libraries 1510 can also include a wide variety of other libraries 1528 to provide many other APIs to the applications 1506.

The frameworks 1508 provide a high-level common infrastructure used by the applications 1506. For example, the frameworks 1508 provide various graphical user interface (GUI) functions, high-level resource management, and high-level location services. The frameworks 1508 can provide a broad spectrum of other APIs that can be used by the applications 1506, some of which may be specific to a particular operating system or platform.

The applications 1506 may include a home application 1536 a contacts application 1530, a browser application 1532, a book reader application 1534, a location application 1542, a media application 1544, a messaging application 1546, a game application 1548, and a broad assortment of other applications such as a third-party application 1540.

Applications 1406 are programs that execute functions defined in the programs. Various programming languages can be employed to create one or more of the applications 1506, structured in a variety of manners, such as object-oriented programming languages (e.g., Objective-C, Java, or C++) or procedural programming languages (e.g., C or assembly language). In a specific example, the third-party application 1540 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1540 can invoke the API calls 1550 provided by the operating system 1512 to facilitate functionality described herein.

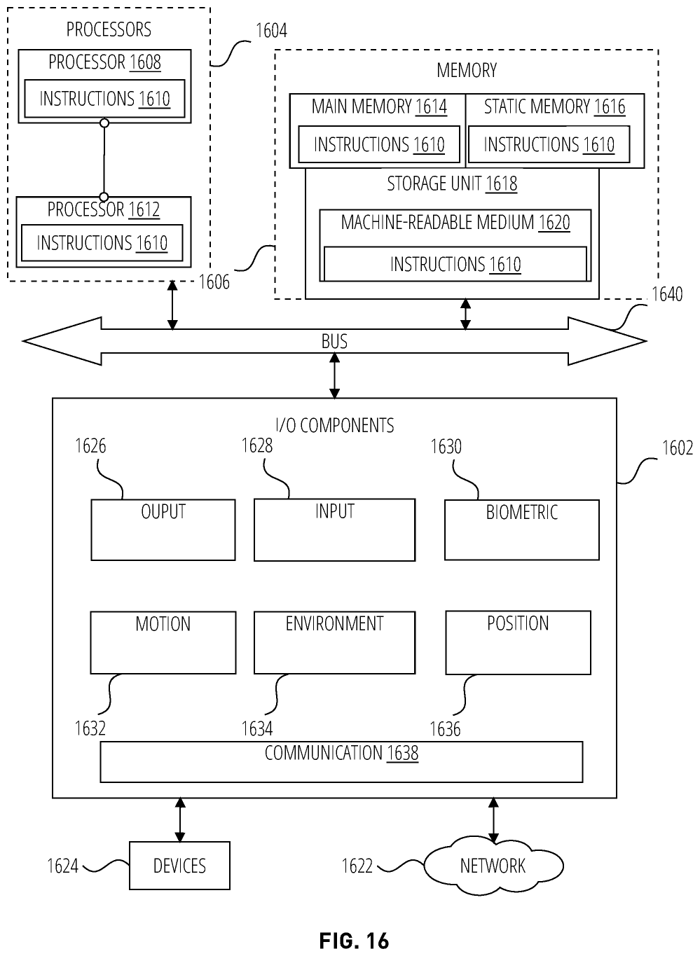

FIG. 16 is a diagrammatic representation of the machine 1502 within which instructions 1610(e.g., software, a program, an application, an applet, an app, or other executable code) for causing the machine 1502 to perform any one or more of the methodologies discussed herein may be executed. For example, the instructions 1610 may cause the machine 1502 to execute any one or more of the methods described herein. The instructions 1610 transform the general, non-programmed machine 1502 into a particular machine 1502 programmed to carry out the described and illustrated functions in the manner described. The machine 1502 may operate as a standalone device or be coupled (e.g., networked) to other machines. In a networked deployment, the machine 1502 may operate in the capacity of a server machine or a client machine in a server-client network environment, or as a peer machine in a peer-to-peer (or distributed) network environment. The machine 1502 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1610, sequentially or otherwise, that specify actions to be taken by the machine 1502. Further, while a single machine 1502 is illustrated, the term “machine” may include a collection of machines that individually or jointly execute the instructions 1610 to perform any one or more of the methodologies discussed herein.

The machine 1502 may include processors 1604, memory 1606, and I/O components 1602, which may be configured to communicate via a bus 1640. In some examples, the processors 2104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 1608 and a Processor 1612 that execute the instructions 1610. The term “Processor” is intended to include multi-core processors that may comprise two or more independent processors (sometimes referred to as “cores”) that may execute instructions contemporaneously. Although FIG. 16 shows multiple processors 1604, the machine 1502 may include a single processor with a single core, a single processor with multiple cores (e.g., a multi-core processor), multiple processors with a single core, multiple processors with multiples cores, or any combination thereof.

The memory 1606 includes a main memory 1614, a static memory 1616, and a storage unit 1618, both accessible to the processors 1604 via the bus 1640. The main memory 1614, the static memory 1616, and storage unit 1618 store the instructions 1610 embodying any one or more of the methodologies or functions described herein. The instructions 1610 may also reside, wholly or partially, within the main memory 1614, within the static memory 1616, within machine-readable medium 1620 within the storage unit 1618 within the processors 1604 (e.g., within the processor's cache memory), or any suitable combination thereof, during execution thereof by the machine 1502.

The I/O components 1602 may include various components to receive input, provide output, produce output, transmit information, exchange information, or capture measurements. The specific I/O components 1602 included in a particular machine depend on the type of machine. For example, portable machines such as mobile phones may include a touch input device or other such input mechanisms, while a headless server machine will likely not include such a touch input device. The I/O components 1602 may include many other components not shown in FIG. 16. In various examples, the I/O components 1602 may include output components 1626 and input components 1628. The output components 1626 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 1628 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1602 may include biometric components 1630, motion components 1632, environmental components 1634, or position components 1636, among a wide array of other components. For example, the biometric components 16 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 1632 include acceleration sensor components (e.g., accelerometer), gravitation sensor components, rotation sensor components (e.g., gyroscope). The environmental components 1634 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1636 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1602 further include communication components 1638 operable to couple the machine 1502 to a network 1622 or devices 1624 via respective coupling or connections. For example, the communication components 1638 may include a network interface Component or another suitable device to interface with the network 1622. In further examples, the communication components 1638 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1624 may be another machine or any of a wide variety of peripheral devices (e.g., a peripheral device coupled via a USB).

Moreover, the communication components 1638 may detect identifiers or include components operable to detect identifiers. For example, the communication components 1638 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 1638, such as location via Internet Protocol (IP) geolocation, location via Wi-Fi® signal triangulation, or location via detecting an NFC beacon signal that may indicate a particular location.

The various memories (e.g., main memory 1614, static memory 1616, and/or memory of the processors 1604) and/or storage unit 1618 may store one or more sets of instructions and data structures (e.g., software) embodying or used by any one or more of the methodologies or functions described herein. These instructions (e.g., the instructions 1610), when executed by processors 1604, cause various operations to implement the disclosed examples.

The instructions 1610 may be transmitted or received over the network 1622, using a transmission medium, via a network interface device (e.g., a network interface component included in the communication components 1638 and using any one of several well-known transfer protocols (e.g., hypertext transfer protocol (HTTP)). Similarly, the instructions 1610 may be transmitted or received using a transmission medium via a coupling (e.g., a peer-to-peer coupling) to the devices 1624.

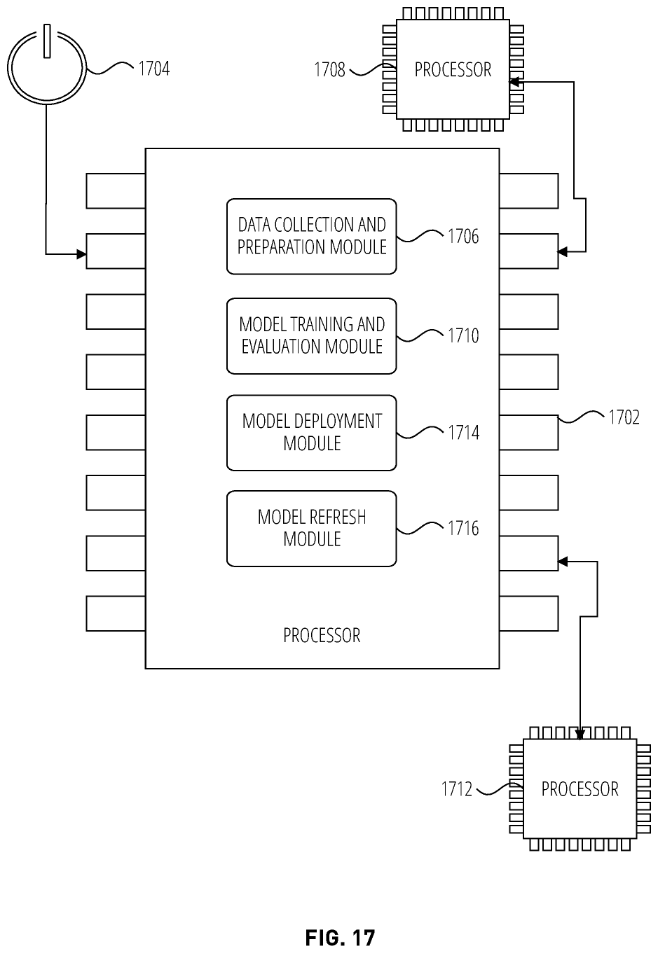

Turning now to FIG. 17, a diagrammatic representation of a processing environment is shown, which includes a processor 1702, a processor 1708 and a processor 1712 (e.g., a GPU, CPU, or combination thereof).

The processor processors 1702 is shown to be coupled to a power source 1704, and to include (either permanently configured or temporarily instantiated) modules, namely a data collection and preparation module 1706, a model training and evaluation module 1710, and a model deployment module 1714.

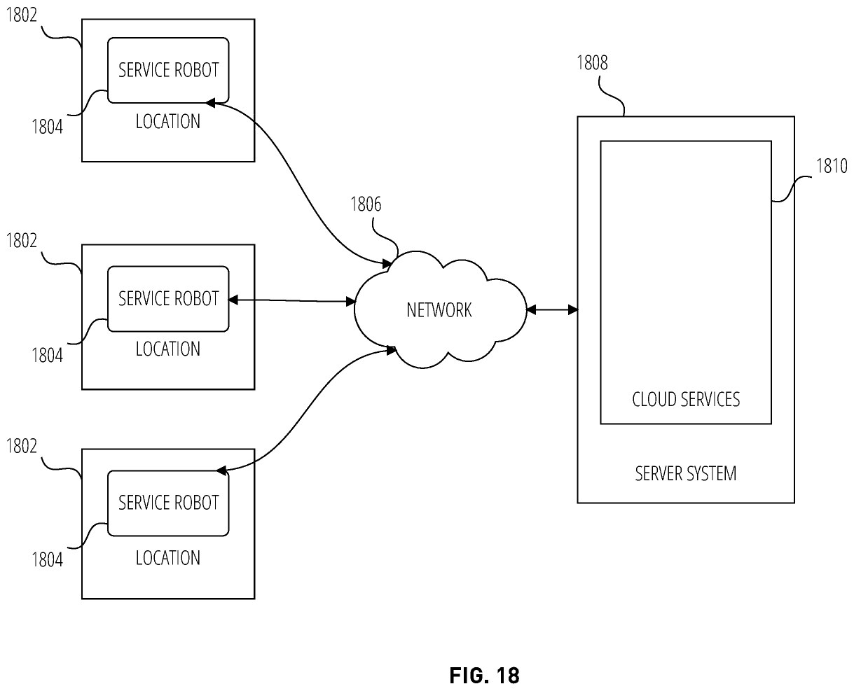

FIG. 18 is a diagrammatic representation of an environment in which multiple service robots 104 (e.g., a fleet of service robots) are deployed to respective locations 1802 or environments, such as restaurants, hospitals, or senior care facilities. Depending on the location, the service robots 104 may perform any one of a number of functions within the location 1802. Taking the example where these locations 1802 are service locations such as restaurants, the service robots 104 may operate to assist with the delivery of items from a kitchen to tables within a particular restaurant, as well as the transportation of plates, trash, etc., from tables back to the kitchen.

Each of the service robots 104 is communicatively coupled by a network 1806, or multiple networks 1806, to cloud services 1810, which reside at one or more server systems 1808.

### EXAMPLES

Example 1 is a computer-implemented method to recover travel of a service robot, the method comprising: detecting a travel impediment relating to a first travel path to a destination for the service robot; responsive to detecting the travel impediment relating to the first travel path to the destination, determining that the service robot is delocalized by performing a comparison between a first pose estimate for the service robot and a first image-based pose estimate for the service robot; responsive to determining that the service robot is delocalized, performing a relocalization operation of the service robot; and responsive to performing the relocalization operation of the service robot, initiating a second travel path to the destination.

In Example 2, the subject matter of Example 1 includes, at a first capture time, using a camera of the service robot to capture a first image; at a first pose computation time, using a first localization model to compute the first pose estimate for the service robot, the first pose computation time to match the first capture time; and wherein the determining that the service robot is delocalized comprises: using a second localization model and the first image to compute the first image-based pose estimate for the service robot; and performing a comparison of the first pose estimate and the first image-based pose estimate.

In Example 3, the subject matter of Example 2 includes, wherein the performing of the relocalization operation of the service robot comprises: initializing the first localization model with the first image-based pose estimate for the service robot; and using the first localization model to compute an updated pose estimate for the service robot.

In Example 4, the subject matter of Examples 2-3 includes, wherein the first localization model is an Adaptive Monte-Carlo Localizer (AMCL) model or a General Monte-Carlo Localizer (GMCL) model.

In Example 5, the subject matter of Examples 2-4 includes, wherein the second localization model is an image-based localization model.

In Example 6, the subject matter of Examples 2-5 includes, wherein: the first pose estimate indicates a first map cell; the first image-based pose estimate indicates a second map cell; and the performing of the comparison of the first pose estimate and the first image-based pose estimate comprises performing a comparison between the first map cell and the second map cell.

In Example 7, the subject matter of Example 6 includes, wherein performing the comparison between the first map cell and the second map cell comprises determining that the first map cell matches the second map cell.

In Example 8, the subject matter of Examples 2-7 includes, wherein the first localization model uses laser scanning data generated by a LiDAR sensor of the service robot.

In Example 9, the subject matter of Examples 2-8 includes, the method further comprising: at a second capture time, using the camera of the service robot to capture a second image; at a second pose computation time, using the first localization model to compute a second pose estimate for the service robot, the second pose computation time to match the second capture time; and wherein the determining that the service robot is delocalized further comprises: using the second localization model and the second image to compute a second image-based pose estimate for the service robot; and performing a comparison of the second pose estimate and the second image-based pose estimate.

In Example 10, the subject matter of Example 9 includes, wherein: the second pose estimate for the service robot indicates a third map cell; the second image-based pose estimate for the service robot indicates a fourth map cell; and the performing of the comparison of the second pose estimate and the second image-based pose estimate comprises performing a comparison of the third map cell and the fourth map cell.

In Example 11, the subject matter of Example 10 includes, wherein the performing of a comparison of the third map cell and the fourth map cell comprises determining that the third map cell matches the fourth map cell.

In Example 12, the subject matter of Examples 9-11 includes, wherein a difference between the second capture time and the first capture time is greater than a predetermined minimum time threshold.

In Example 13, the subject matter of Examples 9-12 includes, wherein a distance between the second image-based pose estimate and the first image-based pose estimate is greater than a predetermined minimum distance threshold.

In Example 14, the subject matter of Examples 1-13 includes, wherein the determining that the service robot is delocalized comprises: performing a rotation-in-place operation of the service robot, the performing of the rotation-in-place operation comprising: at a first capture time, using a camera of the service robot to capture a first image; and at a first pose computation time, using a first localization model to compute the first pose estimate for the service robot, the first pose computation time to match the first capture time; and using a second localization model and the first image to compute a first image-based pose estimate for the service robot; and performing a comparison of the first pose estimate and the first image-based pose estimate.

In Example 15, the subject matter of Examples 7-14 includes, wherein determining that the first map cell matches the second map cell comprises determining that a distance between a center of the first map cell and a center of the second map cell transgresses a first predetermined threshold.

In Example 16, the subject matter of Example 15 includes determining that a distance between a corner of the first map cell and a corner of the second map cell transgresses a second predetermined threshold.

In Example 17, the subject matter of Examples 6-16 includes, wherein: the first pose estimate specifies a first set of coordinates comprising a first x-axis coordinate, a first y-axis coordinate, or a first yaw angle; and the first image-based pose estimate specifies a second set of coordinates comprising a second x-axis coordinate, a second y-axis coordinate, or a second yaw angle.

In Example 18, the subject matter of Example 17 includes, wherein performing the comparison between the first pose estimate and the first image-based pose estimate comprises determining that a distance between the first set of coordinates and the second set of coordinates transgresses a predetermined threshold.

Example 19 is at least one non-transitory machine-readable medium (or computer-readable medium) including instructions that, when executed by processing circuitry, cause the processing circuitry to perform operations to implement of any of Examples 1-18.

Example 20 is an apparatus comprising means to implement any of Examples 1-18.

Example 21 is a system to implement any of Examples 1-18.

What is claimed is:

1. A computer-implemented method to recover travel of a service robot, the method comprising:
detecting a travel impediment relating to a first travel path to a destination for the service robot;
responsive to detecting the travel impediment relating to the first travel path to the destination, determining that the service robot is delocalized by performing a comparison between a first pose estimate for the service robot and a first image-based pose estimate for the service robot;
responsive to determining that the service robot is delocalized, performing a relocalization operation of the service robot; and
responsive to performing the relocalization operation of the service robot, initiating a second travel path to the destination.

2. The method of claim 1, further comprising:
at a first capture time, using a camera of the service robot to capture a first image;
at a first pose computation time, using a first localization model to compute the first pose estimate for the service robot, the first pose computation time to match the first capture time; and
wherein the determining that the service robot is delocalized comprises:
using a second localization model and the first image to compute the first image-based pose estimate for the service robot; and
performing a comparison of the first pose estimate and the first image-based pose estimate.

3. The method of claim 2, wherein the performing of the relocalization operation of the service robot comprises:
initializing the first localization model with the first image-based pose estimate for the service robot; and
using the first localization model to compute an updated pose estimate for the service robot.

4. The method of claim 2, wherein the first localization model is an Adaptive Monte-Carlo Localizer (AMCL) model or a General Monte-Carlo Localizer (GMCL) model.

5. The method of claim 2, wherein the second localization model is an image-based localization model.

6. The method of claim 2, wherein:
the first pose estimate indicates a first map cell;
the first image-based pose estimate indicates a second map cell; and
the performing of the comparison of the first pose estimate and the first image-based pose estimate comprises performing a comparison between the first map cell and the second map cell.

7. The method of claim 6, wherein performing the comparison between the first map cell and the second map cell comprises determining that the first map cell matches the second map cell.

8. The method of claim 2, wherein the first localization model uses laser scanning data generated by a LiDAR sensor of the service robot.

9. The method of claim 2, the method further comprising:
at a second capture time, using the camera of the service robot to capture a second image;
at a second pose computation time, using the first localization model to compute a second pose estimate for the service robot, the second pose computation time to match the second capture time; and
wherein the determining that the service robot is delocalized further comprises:
using the second localization model and the second image to compute a second image-based pose estimate for the service robot; and
performing a comparison of the second pose estimate and the second image-based pose estimate.

10. The method of claim 9, wherein:
the second pose estimate for the service robot indicates a third map cell;
the second image-based pose estimate for the service robot indicates a fourth map cell; and
the performing of the comparison of the second pose estimate and the second image-based pose estimate comprises performing a comparison of the third map cell and the fourth map cell.

11. The method of claim 10, wherein the performing of a comparison of the third map cell and the fourth map cell comprises determining that the third map cell matches the fourth map cell.

12. The method of claim 9, wherein a difference between the second capture time and the first capture time is greater than a predetermined minimum time threshold.

13. The method of claim 9, wherein a distance between the second image-based pose estimate and the first image-based pose estimate is greater than a predetermined minimum distance threshold.

14. The method of claim 1, wherein the determining that the service robot is delocalized comprises:
performing a rotation-in-place operation of the service robot, the performing of the rotation-in-place operation comprising:
at a first capture time, using a camera of the service robot to capture a first image; and
at a first pose computation time, using a first localization model to compute the first pose estimate for the service robot, the first pose computation time to match the first capture time; and
using a second localization model and the first image to compute a first image-based pose estimate for the service robot; and
performing a comparison of the first pose estimate and the first image-based pose estimate.

15. The method of claim 7, wherein determining that the first map cell matches the second map cell comprises determining that a distance between a center of the first map cell and a center of the second map cell transgresses a first predetermined threshold.

16. The method of claim 15, further comprising determining that a distance between a corner of the first map cell and a corner of the second map cell transgresses a second predetermined threshold.

17. The method of claim 6, wherein:
the first pose estimate specifies a first set of coordinates comprising a first x-axis coordinate, a first y-axis coordinate, or a first yaw angle; and
the first image-based pose estimate specifies a second set of coordinates comprising a second x-axis coordinate, a second y-axis coordinate, or a second yaw angle.

18. The method of claim 17, wherein performing the comparison between the first pose estimate and the first image-based pose estimate comprises determining that a distance between the first set of coordinates and the second set of coordinates transgresses a predetermined threshold.

19. A computing apparatus comprising:
a processor; and
a memory storing instructions that, when executed by the processor, configure the apparatus to:
detect a travel impediment relating to a first travel path to a destination for a service robot;
responsive to detecting the travel impediment relate to the first travel path to the destination, determine that the service robot is delocalized by performing a comparison between a first pose estimate for the service robot and a first image-based pose estimate for the service robot;
responsive to determining that the service robot is delocalized, perform a relocalization operation of the service robot; and
responsive to performing the relocalization operation of the service robot, initiate a second travel path to the destination.

20. A non-transitory computer-readable storage medium, the computer-readable storage medium including instructions that when executed by a computer, cause the computer to:
detect a travel impediment relating to a first travel path to a destination for a service robot;
responsive to detecting the travel impediment relate to the first travel path to the destination, determine that the service robot is delocalized by performing a comparison between a first pose estimate for the service robot and a first image-based pose estimate for the service robot;
responsive to determining that the service robot is delocalized, perform a relocalization operation of the service robot; and
responsive to performing the relocalization operation of the service robot, initiate a second travel path to the destination.
